(19) United States
(12) Patent Application Publication
(10) Pub. No.: US 2023/0232157 A1
(43) Pub. Date: Jul. 20, 2023

(54) APPLICATION DEVICE

(71) Applicant: GOERTEK INC., Weifang, Shandong (CN)

(72) Inventors: Chunfa LIU, Weifang, Shandong (CN); Jianbin YANG, Weifang, Shandong (CN); Jianxin WANG, Weifang, Shandong (CN); Shousong QIANG, Weifang, Shandong (CN)

(21) Appl. No.: 17/999,883

(22) PCT Filed: Nov. 7, 2020
(86) PCT No.: PCT/CN2020/127326

§ 371 Date: Nov. 25, 2022

(30) Foreign Application Priority Data
May 25, 2020 (CN) 202010458487.3

(51) Int. Cl. H04R 9/04; H04R 9/06; H04R 7/04

(52) U.S. Cl. CPC H04R 9/043; H04R 9/06; H04R 7/04; H04R 9/025

(57) ABSTRACT

Disclosed is an application device comprising a plurality of elastic members, the elastic member comprises a first connecting portion, a second connecting portion and a deformation portion located between the first connecting portion and the second connecting portion; the first connecting portion and the second connecting portion are connected to different components in the application device respectively, and the different components are movable relative to each other, or the different components may be unmovable relative to each other; the deformation portion is formed by extending from the first end to the second end along the same direction or different directions in a straight line and/or a curved line; and each of the elastic members is integrally formed by punching a sheet-shaped structure.

### TECHNICAL FIELD

The present disclosure relates to a field of electroacoustic technology, and particularly to an application device.

### BACKGROUND ART

An application device, such as a loudspeaker, is an important acoustic component in an electronic apparatus, the application device is a transducer for converting an electrical signal into an acoustic signal. Currently, with the continuous progress and innovation of the technology, the structural design of a traditional loudspeaker is also continuously seeking innovation and change, which not only needs to meet the development trend of thinning, but also needs to pay more and more attention to optimization of performance, and in the meanwhile give consideration to the simplification of the process and the control of cost.

In an existing loudspeaker, a centering supporting sheet is fixedly disposed on a voice coil frame, so as to prevent a voice coil from polarizing in a non-vibration direction in the vibration process, and the centering supporting sheet is generally has a sheet-shaped elastic wave shape. However, the process for manufacturing the centering supporting sheet having the sheet-shaped elastic wave shape is complex, and the centering supporting sheet having the sheet-shaped elastic wave shape may increase the height of the loudspeaker in a vibration direction thereof, and increase the occupied space, which is not conducive to the thinning of the product. Under a condition that the voice coil has a large vibration displacement, the compliance of the centering supporting sheet having the sheet-shaped elastic wave shape is deteriorated, which cannot provide sufficient displacement, on the contrary, a pulling in a direction opposite to a displacement direction of the voice coil may be generated, and thereby affecting the vibration of the voice coil.

### SUMMARY

The main purpose of the present disclosure is to provide an application device, which aims to solve the technical problem in the prior art that the process for manufacturing the centering supporting sheet is complex.

In order to achieve the above purpose, the present disclosure provides an application device, comprising a plurality of elastic members, the elastic member comprises a first connecting portion, a second connecting portion and a deformation portion positioned between the first connecting portion and the second connecting portion; the first connecting portion and the second connecting portion are connected to different components in the application device, respectively, and the different components are movable relative to each other, or the different components are unmovable relative to each other; the deformation portion comprises a first end connected to one of the first connecting portion and the second connecting portion, and a second end connected to the other one of the first connecting portion and the second connecting portion;

the deformation portion is formed by extending from the first end to the second end along the same direction or different directions in a straight line and/or a curved line; and

each of the elastic members is integrally punched and formed by a sheet-shaped structure.

Preferably, the elastic member has a linear bending structure.

Preferably, the deformation portion has a planar structure, and the deformation portion is positioned in the same horizontal plane as the first connecting portion and the second connecting portion.

Preferably, area of the deformation portion close to the first connecting portion and the second connecting portion forms two widened areas in corresponding with the first connecting portion and the second connecting portion, an area of the deformation portion located between the two widened areas is a non-widened area, and a line width of the deformation portion located in the widened area is greater than a line width of the deformation portion in the non-widened area.

Preferably, the deformation portion has an S-shaped bending structure formed by extending from the first end to the second end along the same direction or different directions in a straight line and/or a curved line.

Preferably, a width of the deformation portion gradually increases from the first connecting portion to the second connecting portion, and extension lines of two sides of the deformation portion in a width direction intersect at one point to form an acute angle in a direction that the first connecting portion is far away from the second connecting portion; or the width of the deformation portion gradually decreases from the first connecting portion to the second connecting portion, and the extension lines of the two sides of the deformation portion in the width direction intersect at one point to form an acute angle in a direction that the second connecting portion is far away from the first connecting portion.

Preferably, in the deformation portion, one bending segment is formed by bending the deformation portion once, ends of the two bending segments adjacent to each other are connected by an arc segment, and line widths of the arc segment and the two bending segments connected to the arc segment are the same or gradually changed.

Preferably, line widths of the first connecting portion, the second connecting portion, and the bending segment and the arc segment positioned in the widened area are greater than line widths of the bending segment and the arc segment in the non-widened area.

Preferably, a gap between the first connecting portion and the bending segment adjacent to the first connecting portion, a gap between the two adjacent bending segments, a gap between the second connecting portion and the bending segment adjacent to the second connecting portion, and a diameter of the arc segment are greater than or equal to a thickness of the elastic member.

Preferably, an opening is formed at a position between the two bending segments adjacent to each other oppose to the arc segment, the opening located in the non-widen area is provided with a damping member, and the damping member connects the two bending segments adjacent to each other.

Preferably, a central area is provided between the first end and the second end; and the deformation portion is formed by extending from the first end to the central area along a first direction in a straight line and/or a curve and then extending from the central area to the second end along a direction opposite to the first direction in a straight line and/or a curve.

Preferably, the deformation part has a spiral structure, and the deformation part is formed by spirally extending from the first end to the central area towards the central area in clockwise or anticlockwise direction and then spirally extending from the central area to the second end in anticlockwise or clockwise direction.

Preferably, in the deformation portion, one spiral segment is formed by bending the deformation portion once, and any two spiral segments adjacent to each other are disposed at intervals.

Preferably, line widths of the first connecting portion, the second connecting portion, and the spiral segment positioned in the widened area are greater than a line width of the spiral segment in the non-widened area.

Preferably, a gap between the first connecting portion and the spiral segment adjacent to the first connecting portion, a gap between the two spiral segments adjacent to each other and a gap between the second connecting portion and the spiral segment adjacent to the second connecting portion are greater than or equal to a thickness of the elastic member.

Preferably, a damping member is provided at a gap between the spiral segment connected to the first connecting portion and a spiral segment adjacent thereto, a gap between the spiral segment connected to the second connecting portion and a spiral segment adjacent thereto respectively, and the damping member connects the two spiral segments adjacent to each other.

Preferably, the elastic member is made of any one of phosphor bronze, iron, steel or an alloy material.

Preferably, the application device further comprises a vibration unit, and the elastic member is used to balance the vibration of the vibration unit in a predetermined direction.

Preferably, the vibration unit may have one or more vibration units, and the vibration unit may be disposed in a vertical direction or a horizontal direction.

Preferably, at least three elastic members are provided, and the at least three elastic members are uniformly disposed at intervals along a periphery of the vibration unit.

Preferably, two of the elastic members have conductive body structure, and the remaining elastic members has non-conductive body structure.

Preferably, the application device further comprises a holder, and the vibration unit comprises a diaphragm and a voice coil connected with the diaphragm; the first connecting portion is connected to the voice coil, and the second connecting portion is connected to the holder; or

the vibrating unit comprises a diaphragm, a voice coil and a cup, the voice coil and the cup are connected at the same side of the diaphragm, the first connecting portion is connected with the cup, and the second connecting portion is connected with the holder; and/or
the holder is a housing or a magnetic yoke.

Preferably, the application device is a loudspeaker, a motor or a multi-functional vibrating device.

In the technical solution of the present disclosure, the elastic members are integrally formed by punching a sheet-shaped structure, the manufacture is simple and convenient, the manufacturing process is simplified, the manufacturing efficiency is high, the manufacturing cost is reduced, the flatness and dimensional tolerance of the elastic member formed by punching are easier to control, and the product yield is high. Moreover, the elastic members of the present disclosure do not increase the height of the application device in the vertical direction, occupies a small space, and is conducive to the thinning of the product. In addition, in the elastic members of the present disclosure, the deformation portion extends with a narrow and long structure in a straight line and/or a curved line along the same direction or different directions, so that the stress concentration of the deformation portion can be reduced, the fatigue strength is increased, and the risk of fracture of the elastic member is reduced, so that the elastic members generate enough elastic deformation during the vibration unit moves in the vertical direction, and even if the vibration unit has a large vibration displacement, the elastic members can maintain a good compliance, the elastic member is provided with sufficient displacement without affecting the vibration of the vibration unit, thereby optimizing the product performance.

### BRIEF DESCRIPTION OF THE DRAWINGS

In order to more clearly illustrate the embodiments of the present disclosure or the technical solutions in the prior art, the drawings that need to be used in the embodiments or the prior art are briefly described below, and it is obvious that the drawings in the following description are only some embodiments of the present disclosure, and for those skill in the art, other drawings may be obtained according to the structures shown in the accompanying drawings without creative labor.

FIG. 1 is a schematic top view of an elastic member according to an embodiment of the present disclosure;

FIG. 2 is a schematic cross-sectional view of an elastic member according to the embodiment of the present disclosure;

FIG. 3 is a schematic top view of an elastic member according to another embodiment of the present disclosure;

FIG. 4 is a schematic perspective view of a voice coil and an elastic member in an application device according to an embodiment of the present disclosure;

FIG. 5 is a schematic top view of the voice coil and the elastic member in the application device according to the embodiment of the present disclosure;

FIG. 6 is a schematic front view of the voice coil and the elastic member in the application device according to the embodiment of the present disclosure;

FIG. 7 is a schematic perspective view of a voice coil and an elastic member in an application device according to another embodiment of the present disclosure;

FIG. 8 is a schematic top view of the voice coil and the elastic member in the application device according to further another embodiment of the present disclosure;

FIG. 9 is a schematic cross-sectional view of an application device according to an embodiment of the present disclosure.

### DESCRIPTION OF REFERENCE NUMERALS

| reference | | reference | |
|---|---|---|---|
| numerals | name | numerals | name |
| 10 | elastic member | 14 | damping member |
| 11 | first connecting portion | 20 | voice coil |
| 12 | second connecting | 21 | frame |
| | portion | | |
| 121 | hook portion | 22 | voice coil wire |
| 13 | deformation portion | 30 | elastic member group |
| 131 | widen area | 40 | vibration unit |
| 132 | non-widen area | 50 | magnetic circuit |
| | | | system |
| 133 | bending segment | 51 | magnetic gap |
| 134 | arc segment | 60 | diaphragm |
| 135 | opening | 70 | holder |
| 136 | helical segment | 80 | cup |
| 137 | central area | 100 | application device |

The implementation of the purpose, functional characteristics, and advantages of the present disclosure will be further described in combination with embodiments with reference to the accompanying drawings.

### DETAILED DESCRIPTION OF EMBODIMENTS

The technical solutions in embodiments of the present disclosure will be clearly and completely described below in combination with the drawings in the embodiments of the present disclosure. Obviously, the described embodiments are only part embodiments of the present disclose, but not all embodiments. All of other embodiments obtained by a person of ordinary skill in the art based on the embodiments of the present disclosure without creative labor fall within the protection scope of the present disclosure.

It should be noted that, if the embodiments of the present disclosure relate to a directional indication (such as up, down, left, right, front, back etc.), the directional indication is only used to explain relative position relationship, motion situation, and the like between respective components under a certain specific posture (as shown in the drawings), and if the specific posture changes, the directional indication also changes accordingly.

In addition, if the embodiments of the present disclosure relate to descriptions such as “first” and “second”, the descriptions of “first”, “second” and the like are only used for descriptive purposes, and cannot be understood as indicating or implying the relative importance thereof or implicitly indicating the number of indicated technical features. Thus, the features defined with “first” and “second” may explicitly or implicitly include at least one of the features. In addition, the technical solutions between the respective embodiments may be combined with each other, but must be based on that those of ordinary skill in the art can achieve the technical solutions, and when the combination of the technical solutions is contradictory or cannot be implemented, it should be considered that the combination of the technical solutions does not exist, and is not within the protection scope of the present disclosure.

The present disclosure provides an application device.

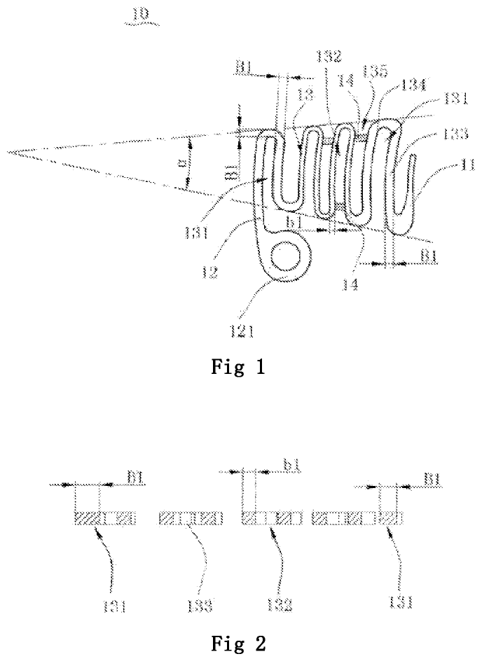

As shown in FIG. 1 to FIG. 6, the application device 100 comprises a plurality of elastic members 10, and each of the elastic members 10 includes a first connecting portion 11, a second connecting portion 12, and a deformation portion 13 located between the first connecting portion 11 and the second connecting portion 12. The first connecting portion 11 and the second connecting portion 12 are connected to different components in the application device 100 respectively, and different components are movable relative to each other, or different components are unmovable relative to each other. The deformation portion 13 comprises a first end connected to one of the first connecting portion 11 and the second connecting portion 12, and a second end connected to the other of the first connecting portion 11 and the second connecting portion 12. The deformation portion 13 is formed by extending from the first end to the second end along the same direction or different directions in a straight line and/or a curved line. Each of the elastic members 10 is integrally formed by punching a sheet-shaped structure.

Specifically, the elastic member 10 may has a linear shape, narrow strip shape, or sheet shape structure integrally formed by punching a metal sheet. The deformation portion 13 has an S-shaped bending structure formed by extending from the first end to the second end in a straight line and/or a curved line. Alternatively, a central area 137 is provided between the first end and the second end, the deformation portion 13 is formed by extending from the first end to the central area 137 along the first direction in a straight line and/or a curved line, and then extending from the central area 137 to the second end along a direction opposite to the first direction in a straight line and/or a curved line. The first direction described above may be a clockwise direction, the shape of the deformation portion 13 may be a polygonal spiral structure, specifically, may be a quadrangle, a pentagon, a hexagon structure or the like, or may be a circular or an elliptical structure, or may be a structure combined by a straight line and a curved line. For example, in the deformation portion 13, one bending segment 133 is formed by bending the deformation portion 13 once, the portion of the bending segment 133 is a straight line, and the other portions are curved line. Specifically, the deformation portion 13 might be a shape in which arc lines and curve lines are alternately combined. It should be noted that the alternately herein is not limited to the case where one object alternates with one object, but may also be the case where one object alternates with many objects and the case where many objects alternate with many objects.

The elastic member 10 is integrally formed into a long and narrow structure by bending and extending, wherein the deformation portion 13 may have a spiral structure, and is formed by spirally extending from the first end thereof to the central area 137 in clockwise direction, and then extending from the central area 137 to the second terminal in anticlockwise direction. The deformation portion 13 may also have a square-shaped spiral-like structure, and is formed by extending form the first end thereof to the central area 137 in a straight line and a curved line respectively, and then extending from the central area 137 to the second end in a curved line and a straight line. The deformation portion 13 may also have another structure formed into a narrow and long structure by bending and extending, and the structure of the deformation portion 13 may be configured according to actual use requirements, and the elastic member 10 does not limit the structure of the deformation portion 13 in the application device 100 of the present disclosure.

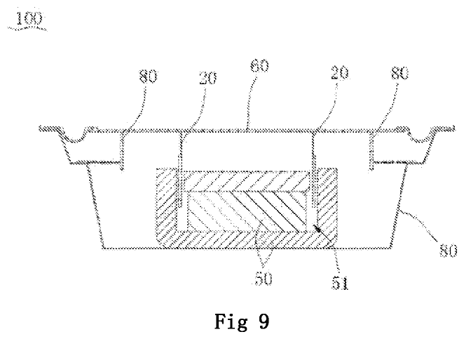

As shown in FIG. 9, the elastic member 10 of the present embodiment is applied to the application device 100 such as a loudspeaker, a motor or a multi-functional vibration device, etc., and this embodiment is described by an example of applying the elastic member 10 as a loudspeaker. The loudspeaker comprises the elastic member 10 and a vibration unit 40, and the elastic member 10 is used to balance the vibration of the vibration unit 40 in a predetermined direction. The loudspeaker further comprises a holder 70. In an embodiment, the vibration unit 40 includes a diaphragm 60 and a voice coil 20 connected to the diaphragm 60; the first connecting portion 11 of the elastic member 10 is connected to the voice coil 20, the second connecting portion 12 is connected to a holder 70, and/or the holder 70 is a housing or a magnetic yoke. In another embodiment, the vibration unit 40 includes a diaphragm 60, a voice coil 20 and a cup 80, the voice coil 20 and the cup 80 are connected to the same side of the diaphragm 60, the first connecting portion 11 is connected to the cup 80, the second connecting portion 12 is connected to a holder 70, and/or the holder 70 is a housing or a magnetic yoke.

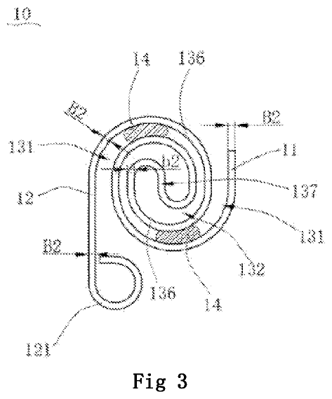

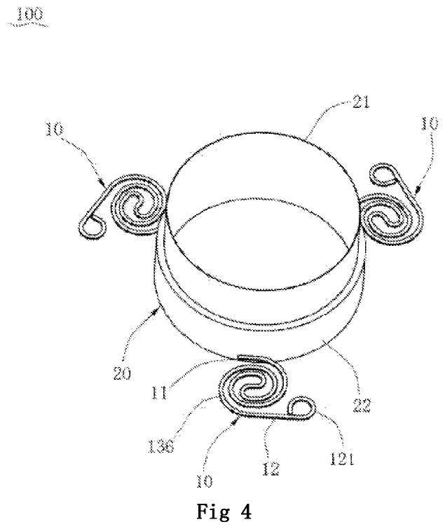

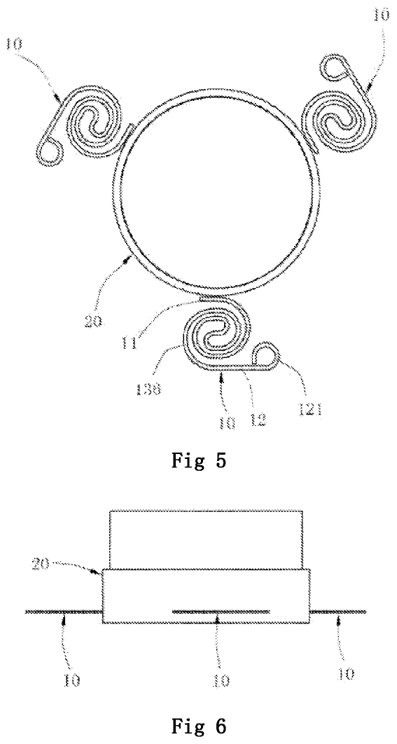

It can be understood that the plurality of elastic members 10 of the application device 100 are disposed at intervals along the periphery of the vibration unit 40, and after the vibration unit 40 is powered on by an electrical signal, the vibration unit 40 may vibrate in an up-down direction inside the housing, wherein the up-down direction is the direction as shown in FIG. 3, the vibration direction of the vibration unit 40 is represented by a vertical direction or the up-down direction, and the direction perpendicular to the vibration direction of the vibration unit 40 is represented by a horizontal direction. As shown in FIG. 4, in an embodiment, the first connecting portion 11 of the elastic member 10 is connected to the voice coil 20, and specifically, the voice coil 20 includes a frame 21 and a voice coil wire 22 wound around the frame 21, and the first connecting portion 11 may be connected to the frame 21 or connected to the voice coil wire 22. The second connecting portion 12 of the elastic member 10 is connected to the housing, so as to achieve the assembling of the voice coil 20, the elastic member 10 and the housing. In another embodiment, the first connecting portion 11 is connected to the cup 80, and the second connecting portion 12 is connected to the housing. In other embodiments, the first connecting portion 11 is connected to the cup 80, the second connecting portion 12 is connected to the magnetic yoke, or the first connecting portion 11 is connected to the voice coil 20, and the second connecting portion 12 is connected to the magnetic yoke.

As shown in FIG. 9, specifically, in an embodiment, the application device 100 includes a vibration unit 40, a magnetic circuit system 50, and a housing for mounting and fixing the vibration unit 40 and the magnetic circuit system 50, wherein, the vibration unit 40 includes a diaphragm 60 and a voice coil 20 coupled to the lower portion of the diaphragm 60; the magnetic circuit system 50 comprises an upper magnetic conductive plate, a magnet and a lower magnetic conductive plate, wherein the upper magnetic conductive plate and the lower magnetic conductive plate are magnetic conductive structures for correcting magnetic lines of force generated by the magnet, the magnetic circuit system 50 forms a magnetic gap 51, and the voice coil 20 is disposed in the magnetic gap 51 of the magnetic circuit system 50. The lower magnetic conductive plate of the present disclosure may have a U-shaped structure, and comprises a bottom wall and a side wall, a magnetic gap 51 is formed between the upper magnetic conductive plate, the magnet and the side wall of the lower magnetic conductive plate, a relatively uniform magnetic field is formed in the magnetic gap 51, and the voice coil 20 is disposed in the magnetic gap 51 having a relatively uniform magnetic field. The voice coil 20 is generally formed by winding a metal wire, and when the voice coil 20 is powered on by an electrical signal, the voice coil 20 vibrates up and down under the action of Ampere force in the magnetic field, the vibration direction of the voice coil 20 is represented by a vertical direction or an up-down direction, and the direction perpendicular to the vibration direction of the voice coil 20 is represented by a horizontal direction. Since the diaphragm 60 and the voice coil 20 are fixedly combined and integrated by bonding or the like, the voice coil 20 also drives the diaphragm 60 to vibrate when it vibrates up and down according to the electric signal to generate sound waves.

However, since the magnetic field in the magnetic gap 51 is merely relatively uniform and is not absolute uniform, the position of the voice coil 20 may also changes in the process during the voice coil 20 vibrates, and the magnetic line of force on an upper side of the magnetic gap 51 is an arc-shaped line, so that the ampere force applied on the voice coil 20 is not merely in a vertical direction, but also contains an ampere force in other directions, which causes that the voice coil 20 prone to generate polarization in a non-vertical direction in the process of a vibration, and further affects the vibration of the diaphragm 60.

In order to prevent the above polarization from occurring, the providing of the elastic member 10 connecting the voice coil 20 and the holder 70 may perform centering support with respect to the polarization of the voice coil 20, that is, to ensure that the voice coil 20 vibrates in the vibration direction within the magnetic gap 51. In an embodiment, the elastic member 10 is a centering supporting sheet or a planar spring.

In an embodiment, the vibration unit 40 further includes a cup 80 disposed on the diaphragm 60, and the cup 80 and the voice coil 20 are connected to the same side of the diaphragm 60. When there is a magnetic gap 51, the cup 80 is located outside the magnetic gap 51, and the providing of the elastic member 10 connecting the cup 80 and the holder 70 may also perform centering support with respect to the polarization of the voice coil 20, that is, to ensure that the voice coil 20 vibrates in the vibration direction within the magnetic gap 51.

In an embodiment, the holder 70 is a housing or a magnetic yoke, since the housing can be used for supporting the loudspeaker unit, configuring the holder 70 as a housing can facilitate to fix a side of the elastic member 10 away from the vibration unit 40, thereby improving the centering support effect of the elastic member 10. Since most portions of the vibration unit 40 are close to the magnetic gap 51, the vibration unit 40 is closer to the magnetic yoke, and connecting the side of the elastic member 10 away from the vibration unit 40 to the magnetic yoke can reduce the distance for arranging the elastic member, and it is convenient to improve the centering support effect of the elastic member 10. It should be noted that, as described above, in this embodiment, the fixing methods of the elastic member 10 includes a plurality of combinations: the first connecting portion 11 and the second connecting portion 12 of the elastic member 10 are connected to the voice coil 20 and the housing respectively, or the first connecting portion 11 and the second connecting portion 12 of the elastic member 10 are connected to the voice coil 20 and the magnetic yoke respectively, or the first connecting portion 11 and the second connecting portion 12 of the elastic member 10 are connected to the cup 80 and the housing respectively, or the first connecting portion 11 and the second connecting portion 12 of the elastic member 10 are respectively connected to the cup 80 and the magnetic yoke, which can ensure a better centering support effect of the elastic member 10.

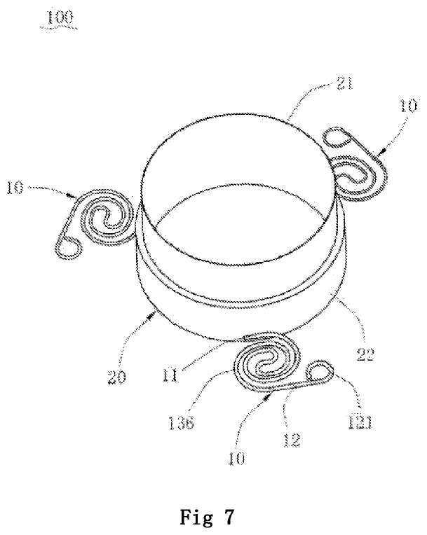

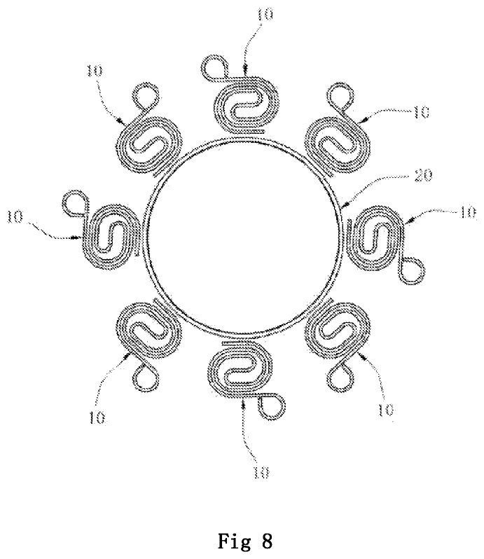

It can be understood that, after the vibration unit 40 is powered on by an electrical signal, the vibration unit 40 may vibrate in the up-down direction, wherein the up-down direction is the direction as shown in FIG. 6, the vibration direction of the vibration unit 40 is represented by a vertical direction or the up-down direction, and the direction perpendicular to the vibration direction of the vibration unit 40 is represented in a horizontal direction. As shown in FIG. 4, FIG. 7 and FIG. 8, in an embodiment, the first connecting portion 11 of the elastic member 10 is connected to the voice coil 20, and specifically, the voice coil 20 includes a frame 21 and a voice coil wire 22 wound around the frame 21, and the first connecting portion 11 may be connected to the frame 21 or also may be connected to the voice coil wire 22. The second connecting portion 12 of the elastic member 10 is connected to the housing, to achieve the assemble of the voice coil 20, the elastic member 10 and the housing. As shown in FIG. 9, in another embodiment, the first connecting portion 11 is connected to the cup 80, and the second connecting portion 12 is connected to the housing. In other embodiments, the first connecting portion 11 is connected to the cup 80, the second connecting portion 12 is connected to the magnetic yoke, or the first connecting portion 11 is connected to the voice coil 20, and the second connecting portion 12 is connected to the magnetic yoke.

The providing of the elastic member 10 of the present embodiment restricts the movement of the vibration unit 40 in horizontal direction when the vibration unit 40 vibrates in vertical direction, to prevent the vibration unit 40 from polarizing, and the elastic member 10 moves in the vertical direction following with the vibration unit 40. Compared with the existing sheet-shaped wavy shaped elastic connector, the elastic member 10 of the present embodiment is integrally formed by punching a sheet shaped structure, and may has a linear shape, a narrow strip shape or a sheet shape structure that is integrally formed by punching a metal sheet, the manufacturing is simple and convenient, the manufacturing process is simplified, manufacturing efficiency is high and the manufacturing cost is reduced, and the flatness and dimensional tolerance of the elastic member 10 formed by punching is easier to control, and the product yield is high. Moreover, the elastic member 10 of the present embodiment does not increase the height of the application device 100 in the vertical direction, occupies a small space, and is facilitating the thinning of the product. In addition, in the elastic member 10 of the present embodiment, the deformation portion 13 extends with a long and narrow structure in a straight line and/or a curved line along the same direction or different directions, so that the stress concentration of the deformation portion 13 can be reduced, the fatigue strength is increased, and the risk of breakage of the elastic member 10 is reduced. Thus, in the process during the elastic member 10 moves in the vertical direction following with the vibration unit 40, an elastic deformation of the deformation portion 13 is sufficiently large, and even in the case where the vibration unit 40 has a large vibration displacement, the elastic member maintains a good compliance, so that sufficient displacement can be provided, the vibration of the vibration unit 40 is not affected, and the product performance is optimized.

In the embodiment, the elastic member 10 has a linear bending structure, and is easy to manufacture, and can provide good compliance when the voice coil 20 has a large vibration displacement. After forming by punching, the cross section of the elastic member 10 of the present embodiment has a shape such as a square shape or a rectangle shape, or may have other flat shapes. Further, the deformation portion 13 of the elastic member 10 has a planar structure, and the deformation portion 13 is located in the same horizontal plane as the first connecting portion 11 and the second connecting portion 12, so that the elastic member 10 has a planar structure as a whole. Compared with the existing sheet-shaped wavy shaped elastic connector 10, in the present embodiment, the overall flatness of the elastic member 10 is improved, the height of the application device 100 in the vertical direction is further reduced, and the design concept of thinning the product is achieved.

In this embodiment, two widen areas 131 are formed in correspondence with the area of the deformation portion 13 located close to the first connecting portion 11 and the second connecting portion 12, and the area of the deformation portion 13 located between the two widen areas 131 is a non-widen area 132, and a line width of the deformation portion 13 in the widen area 131 is greater than a line width of the deformation portion 13 in the non-widen area 132. It can be understood that the area of the deformation portion 13 located close to the first connecting portion 11 and the second connecting portion 12 generates a large displacement, has a large elastic deformation, and has a large stress concentration. In this embodiment, the areas of the deformation portion 13 located close to the first connecting portion 11 and the second connecting portion 12 are respectively configured as two widen areas 131, the area of the deformation portion 13 located between the two widen areas 131 is configured as the non-widen area 132, and the line width of the deformation portion 13 located in the widen area 131 is widened, so that the line width of the deformation portion 13 of the widen area 131 is greater than the line width of the non-widen area 132, thereby facilitating reducing stress concentration, avoiding breakage from occurring, and ensuring the normal use of the elastic member 10. In addition, in this embodiment, the line width of the deformation portion 13 is locally widened, thus the overall vibration frequency of the elastic member 10 can be changed, resonance is eliminated, and the product performance is optimized.

As shown in FIG. 1 and FIG. 2, in an embodiment, the deformation portion 13 has an S-shaped bending structure formed by extending from the first end to the second end in a straight line and/or a curved line, and specifically, the first end of the deformation portion 13 is connected to the first connecting portion 11, the second end of the deformation portion 13 is connected to the second connecting portion 12, the deformation portion 13 is formed by extending from the first end to the second end in S-shaped curve, and the direction of extending in S-shaped curve is consistent with the direction from the first connecting portion 11 to the second connecting portion 12. The elastic member 10 is bent in an S-shape as a whole, and the elastic member 10 bent in an S-shaped has a large elastic deformation, and can provide a good compliance when the vibration unit 40 has a large vibration displacement. The shape of the elastic member 10 of the present disclosure may be flexibly configured according to the actual requirements, and in other embodiments, the elastic member 10 may also has a spiral shape, a snake-like shape or other shapes.

In an embodiment, the width of the deformation portion 13 gradually increases from the first connecting portion 11 to the second connecting portion 12, and the extension lines of the two sides in the width direction of the deformation portion 13 intersect at one point to form an acute angle α in the direction of the first connecting portion 11 away from the second connecting portion 12. Wherein, the angle value of the acute angle α has a very obvious effect on the mechanical stiffness of the elastic member 10. In the case that other parameters are the same, the larger the angle value of the acute angle α is, the mechanical stiffness KMS value is reduced, and the greater the elastic variation when the deformation portion 13 of the elastic member 10 elastically deforms, the better the linear performance of the elastic member 10 is. In a preferred embodiment, the angle of the acute angle α is not less than 10°.

In another embodiment, the width of the deformation portion 13 gradually decreases from the first connecting portion 11 to the second connecting portion 12, and the extension lines of the two sides in the width direction of the deformation portion 13 intersect at one point to form an acute angle α in the direction of the second connecting portion 12 away from the first connecting portion 11. The present embodiment flexibly adjusts the structure of the deformation portion 13 according to the actual requirements of the application device 100, and the present embodiment has the same effect as the above embodiment, and the details will not be described herein again. Based on the same reason as the above embodiment, the angle of the acute angle α is not less than 10°.

In the present embodiment, one bending segment 133 is formed by bending the deformation portion 13 once, the ends of two adjacent bending segments 133 are connected by an arc segment 134, and the line widths of the arc segment 134 and the two bending segments 133 connected to the arc segment 134 are configured equal or gradually changed. The arc segment 134 may function transition effect to avoid large stress concentration caused by direct bending between two adjacent bending segments 133. In an embodiment, the line widths of the arc segment 134 and the two bending segments 133 connected to the arc segment 134 are equal, so as to be convenient for manufacturing. In another embodiment, the line widths of the arc segment 134 and the two bending segments 133 connected to the arc segment 134 are configured such that gradually changed, so that the line width of the arc segment 134 can be flexibly adjusted according to the stress concentration condition, and the stress concentration can be reduced.

The line widths of the first connecting portion 11, the second connecting portion 12 and the bending segment 133 and the arc segment 134 located in the widened area 131 are wider than the line widths of the bending segment 133 and the arc segment 134 in the non-widened area 132, therefore the areas having large elastic deformation such as the first connecting portion 11, the second connecting portion 12 and the bending segment 133 and the arc segment 134 located in the widened area 131 are locally widened, in this way, the stress concentration of the elastic member 10 is further reduced, and the process of locally widening can change the overall vibration frequency of the elastic member 10, eliminate the resonance, and optimize the product performance. In an embodiment, the line width of the first connecting portion 11, the second connecting portion 12 and the bending segment 133 and the arc segment 134 located in the widened area 131 is B1, and the line width of the bending segment 133 and the arc segment 134 in the non-widened area 132 is b1, where b1<B1≤≤8b1.

In this embodiment, a gap between the first connecting portion 11 and the bending segment 133 adjacent to the first connecting portion 11, a gap between two adjacent bending segments 133, a gap between the second connecting portion 12 and the bending segment 133 adjacent to the second connecting portion 12, and a diameter of the arc segment 134 are all greater than or equal to a thickness of the elastic member 10, so as to convenient for manufacturing by punching. In this embodiment, the thickness of the elastic member 10 may be 0.1 mm to 0.5 mm, and the above-described gaps and the diameter of the arc segment 134 may be set to be 1.5 times of the thickness of the elastic member 10.

In this embodiment, an opening 135 is formed at a position between two adjacent bending segments 133 oppose to the arc segment 134, the opening 135 located in the non-widened area 132 is provided with a damping member 14, and the damping member 14 connects two adjacent bending segments 133. The material of the damping member 14 comprises at least one of a metal material, a rubber material, a silica gel material, a glue material and a foam cotton material; and/or the shape of the damping member 14 is configured in a sheet-shaped structure or a linear structure, and it will be sufficient merely by connecting two adjacent bending segments 133.

In an embodiment, the damping member 14 is a damping glue, the elastic member 10 is locally coated with the damping glue or injection-molded with the damping glue in the non-widen area 132, the damping glue is located at the opening 135 and connects two adjacent bending segments 133, the damping glue improves the resonance frequency of the elastic member 10, eliminates the resonance, and further optimizes the product performance.

As shown in FIG. 3 to FIG. 9, in another embodiment, a central area 137 is provided between the first end and the second end of the deformation portion 13; the deformation portion 13 is formed by extending from the first end to the central area 137 along a first direction in a straight line and/or a curved line and then extending from the central area 137 to the second end along a direction opposite to the first direction in a straight line and/or a curved line. Specifically, the deformation portion 13 has a spiral structure, the deformation portion 13 spirally extends from the first end to the central area 137 in clockwise or anticlockwise, and spirally extends then from the central area 137 in anticlockwise or clockwise direction, so that the deformation portion 13 has a spiral structure spirally extending in two directions opposite to each other, has a large elastic deformation, and provides good compliance when the vibration unit 40 has a large vibration displacement. The first connecting portion 11 and the second connecting portion 12 are correspondingly located on both sides of the deformation portion 13 respectively, the first end and the second end of the deformation portion 13 may be arbitrarily correspondingly connected to the first connecting portion 11 or the second connecting portion 12, that is, the first end of the deformation portion 13 is connected to the first connecting portion 11, and the second end of the deformation portion 13 is connected to the second connecting portion 12, or the first end of the deformation portion 13 is connected to the second connecting portion 12, and the second end of the deformation portion 13 is connected to the first connecting portion 11. Further, the deformation portion 13 has a central symmetry structure around the center point thereof, so as to convenient for manufacturing, and on the other hand, the first end and the second end of the deformation portion 13 can be interchanged, so as to convenient to use.

In another embodiment, the deformation portion 13 has a square shaped spiral-like structure, the deformation portion 13 is formed by extending from the first end to the central area 137 along a straight line and a curved line respectively, and then extending from the central area 137 to the second end along the curved line and the straight line respectively, so that the deformation portion 13 has a spiral-like structure extending in a straight line and a curved line along two directions opposite to each other, has a large elastic deformation, and provides good compliance when the vibration unit 40 has a large vibration displacement. The first connecting portion 11 and the second connecting portion 12 are correspondingly located on both sides of the deformation portion 13 respectively, the first end and the second end of the deformation portion 13 may be arbitrarily correspondingly connected to the first connecting portion 11 or the second connecting portion 12, that is, the first end of the deformation portion 13 is connected to the first connecting portion 11, and the second end of the deformation portion 13 is connected to the second connecting portion 12, or the first end of the deformation portion 13 is connected to the second connecting portion 12, and the second end of the deformation portion 13 is connected to the first connecting portion 11. According to the present disclosure, the deformation part 13 can be flexibly configured in a spiral structure or a square spiral-like structure according to actual requirements, which is simple and convenient.

In the present embodiment, in the deformation portion 13, one spiral segment 136 is formed by bending the deformation portion 13 once, and any two adjacent spiral segments 136 are disposed at intervals to provide sufficient elastic deformation. Further, the interval between any two adjacent spiral segments 136 is at least greater than twice the width of a cross section of the spiral segment 136, to further improve the elastic deformation degree of the deformation portion 13. In addition, the deformation portion 13 having a spiral structure can reduce the stress concentration on the deformation portion 13, increase the fatigue strength, and reduce the risk of breakage of the elastic member 10, and on the other hand, can provide sufficient processing space, avoid scratching the wire by the cutting tool during the processing, and ensure that the performance of the elastic member 10 is not affected.

In the deformation portion 13, one spiral segment 136 is formed by bending the deformation portion 13 once, and any two adjacent spiral segments 136 are disposed at intervals to provide sufficient elastic deformation. Further, the interval between any two adjacent spiral segments 136 is at least greater than twice of a line width of the spiral segment 136, and the elastic deformation degree of the deformation portion 13 is further improved. In order to further reducing the stress concentration on the area having larger elastic deformation, the line width of the spiral segment 136 may be configured such that gradually changed, for example, widening a local area having a large elastic deformation, specifically, the line widths of the first connecting portion 11, the second connecting portion 12 and the spiral segment 136 located in the widened area 131 is greater than the line width of the spiral segment 136 in the non-widen area 132. Besides, locally widening the spiral segment 136 in the widened area 131 can change the overall vibration frequency of the elastic member 10, eliminate the resonance, and optimize the product performance. In the present embodiment, the line widths of the first connecting portion 11, the second connecting portion 12 and the spiral segment 136 located in the widened area 131 is B2, and the line width of the spiral segment 136 in the non-widen area 132 is b2, wherein b2<B2≤8b2.

Further, a gap between the first connecting portion 11 and the spiral segment 136 adjacent to the first connecting portion 11, a gap between two adjacent spiral segments 136, and a gap between the second connecting portion 12 and the spiral segment 136 adjacent to the second connecting portion 12 are all greater than or equal to the thickness of the elastic member 10, so as to facilitate to be manufactured by punching. In the present embodiment, the thickness of the elastic member 10 may be 0.1 mm to 0.5 mm, and the above-described gaps may be configured to be 1.5 times of the thickness of the elastic member 10.

Damping member 14 are provided at each of a gap between the spiral segment 136 connected to the first connecting portion 11 and the spiral segment 136 adjacent thereto and a gap between the spiral segment 136 connected to the second connecting portion 12 and the spiral segment 136 adjacent thereto, and the damping member 14 connects two adjacent spiral segments 136. The material of the damping member 14 comprises at least one of a metal material, a rubber material, a silica gel material, a glue material and a foam cotton material; and/or the shape of the damping member 14 is configured in a sheet-like structure or a linear structure, and it will be sufficient merely by connecting two adjacent spiral segments 136.

In an embodiment, the damping member 14 is a damping glue, and the spiral segment 136 connected to the first connecting portion 11 has a large amplitude, therefore the damping glue is locally coated or injection-molded at a gap between the spiral segment 136 and the spiral segment 136 adjacent thereto, the damping glue connects the two spiral segments 136, so as to improve the resonance frequency of the elastic member 10, eliminate the resonance, and further optimize the product performance. Similarly, the spiral segment 136 connected to the second connecting portion 12 has a large amplitude, therefore the damping glue is locally coated or injection-molded at the gap between the spiral segment 136 and the spiral segment 136 adjacent thereto, the damping glue connects the two spiral segments 136, so as to improve the resonance frequency of the elastic member 10, eliminate the resonance, and further optimize the product performance.

An existing elastic wave material is easily affected by the environmental variation, is tends to deform in a high-temperature and high-humidity environment, has a change in hardness, and is poor in fatigue resistance. The elastic member 10 of the present disclosure is made of any one of phosphor bronze, iron, steel or alloy materials, it is not easily affected by environmental variation, it is not easy to deform in a high-temperature and high-humidity environment, it does not change in hardness, and it has good fatigue resistance, so that the application device 100 can operate in a severe environment, optimize the product performance, and improve the application range of the application device 100.

The application device 100 is a loudspeaker, a motor or a multi-functional vibration apparatus, and has a wide application range. The present disclosure is described by an example of applying the application device 100 as a loudspeaker, the application device 100 includes a vibration unit 40 and the above-described elastic member 10, and the elastic member 10 is used to balance the vibration of the vibration unit 40 in a predetermined direction. The vibration unit 40 may be configured in one or more, and the vibration unit 40 may be arranged in a vertical direction or a horizontal direction. Wherein, the application device 100 further includes a holder 70, and in one embodiment, the vibration unit 40 includes a diaphragm 60 and a voice coil 20 connected to the diaphragm 60; the first connecting portion 11 is connected to the voice coil 20, the second connecting portion 12 is connected to the holder 70, and/or the holder 70 is a housing or a magnetic yoke. Alternatively, in another embodiment, the vibration unit 40 includes a diaphragm 60, a voice coil 20 and a cup 80, the voice coil 20 and the cup 80 are connected to the same side of the diaphragm 60, the first connecting portion 11 is connected to the cup 80, the second connecting portion 12 is connected to the holder 70, and/or the holder 70 is a housing or a magnetic yoke. The specific structure of the elastic member 10 in the application device 100 refers to the above embodiments, and since the application device 100 of the present disclosure adopts all the technical solutions of all the above embodiments, and thereby includes at least all of the beneficial effects obtained by the technical solutions of the above embodiments, which will not be repeated herein.

In the application device 100 of the present embodiment, at least three elastic members 10 are provided, and the at least three elastic members 10 are evenly disposed at intervals along the periphery of the vibration unit 40. In one embodiment, three elastic members 10 are provided, the three elastic members 10 are evenly disposed at intervals along the periphery of the vibration unit 40, so that the effect of centering the voice coil 20 is enhanced, and specifically, the three elastic members 10 constrain the vibration unit 40 in at least three positions in the horizontal direction when the vibration unit 40 vibrates in the vertical direction, so that the vibration unit 40 can be prevented from polarizing, and the elastic member 10 moves in the vertical direction following with the vibration unit 40, thereby enhancing the effect of centering the vibration unit 40. In other embodiments, the elastic members 10 may be configured in four, five, six, or other numbers. The number of the elastic members 10 in the application device 100 of the present disclosure can be flexibly adjusted according to actual requirements, and the number of the elastic members 10 is not limited in the present disclosure.

The application device 100 may include at least one elastic member group 30, one elastic member group 30 includes at least three elastic members 10 located on the same horizontal plane. In the same elastic member group 30, the three elastic members 10 may have the same shape or different shapes, for example, in the three elastic members 10 of the same elastic member group 30, one of the elastic members 10 may be bent in a S shape, and the other two elastic members 10 may be bent in a spiral shape. In addition, in the same elastic member group 30, the line widths or materials of the three elastic members 10 may be the same or different. For example, due to the different material attributes, in the three elastic members 10, the material of one of the elastic members 10 is phosphor bronze, and the line width thereof may be set as 0.4 mm, the material of the other elastic member 10 is beryllium copper, the line width thereof may be set as 0.3 mm, and the material of remaining elastic member 10 is 316 steel, the line width thereof may be set as 0.2 mm.

In addition, in the three elastic members 10 of the same elastic member group 30, two elastic members 10 among them have conductive body structures, and the remaining elastic member 10 has a non-conductive body structure. The elastic member 10 of the conductive body structure has a conductive function, and can transmit an electrical signal to the vibration unit 40 of the application device 100, and specifically, the elastic member 10 is electrically connected and assembled to the wiring portion of the voice coil 20 by the first connecting portion 11 thereof, and the second connecting portion 12 is connected to an external power source, so as to transmit the electrical signal between the vibration unit 40 and the outside through the elastic member 10. In addition, the elastic member 10 also restrains the reciprocating vibration of the vibration unit 40 according to the vibration offset state of the vibration unit 40 through the elastic deformation of the deformation portion 13 thereof, so that the vibration unit 40 is stably located at a preset central area, the polarization of the vibration unit 40 is prevented, and the reciprocating vibration of the vibration unit 40 is more stable. Therefore, the elastic member 10 has both functions of electrical conductive and centering, that is, realizing the integration of the two functions, and thereby it will achieve the conduction effect on the internal and external circuits and the centering effect on the vibration of the voice coil 20 merely by arranging two elastic members 10 of the present disclosure in the application device 100, in this way, not only the space in the cavity of the application device 100 can be reduced, but also the thinning of the product can be further facilitated, and the assembly process of the application device 100 is effectively simplified.

The application device 100 may include a plurality of elastic member groups 30, such as two or three elastic member groups 30. Taking two elastic member groups 30 as example to describe, the two elastic member groups 30 are disposed at intervals in the vertical direction of the vibration unit 40, each elastic member group 30 includes four elastic members 10, and the four elastic members 10 are located in the same horizontal plane, and the eight elastic members 10 of the two elastic member groups 30 are disposed in a misaligned manner in the vertical direction, this arrangement not only enhances the centering effect on the vibration unit 40, but also has good mechanical stiffness KMS symmetry and flatness, and meets the fatigue requirements for large displacement. Compared with one elastic member group 30, the plurality of elastic member groups 30 enhance the centering effect on the vibration unit 40, and on the other hand, reduce stress concentration, so as to correspondingly reduce the line width of the elastic member 10 and thereby the elastic member 10 is easier to manufacture.

In the application device 100 of the present disclosure, the number and arrangement mode of the elastic member group 30, and the shape, structure, line width, material and attribute and the like of each elastic member group 30 may be flexibly disposed according to actual requirements, and the elastic member group 30 has a good compatibility and a wide application range.

The above is only a preferred embodiment of the present disclosure, therefore is not intended to limit the scope of the present disclosure, and under the inventive concept of the disclosure, any equivalent structural transformation made by using the description and drawings of the present disclosure or directly/indirectly applied to other related technical fields is included within the scope of the patent protection of the present disclosure.

1. An application device, comprising a plurality of elastic members, the elastic member comprises a first connecting portion, a second connecting portion and a deformation portion located between the first connecting portion and the second connecting portion; the first connecting portion and the second connecting portion are connected to different components in the application device, respectively, and the different components are movable relative to each other, or the different components are unmovable relative to each other;
the deformation portion comprises a first end connected to one of the first connecting portion and the second connecting portion, and a second end connected to the other one of the first connecting portion and the second connecting portion;
the deformation portion is formed by extending from the first end to the second end in the same direction or different directions in a straight line and/or a curved line; and
each of the elastic members is integrally formed by punching a sheet-shaped structure.

2. The application device according to claim 1, wherein the elastic member has a linear bending structure.

3. The application device according to claim 2, wherein the deformation portion has a planar structure, and the deformation portion is located in the same horizontal plane as the first connecting portion and the second connecting portion.

4. The application device according to claim 2, wherein area of the deformation portion close to the first connecting portion and the second connecting portion forms two widened areas in corresponding with the first connecting portion and the second connecting portion, an area of the deformation portion located between the two widened areas is a non-widened area, and a line width of the deformation portion located in the widened area is greater than a line width of the deformation portion in the non-widened area.

5. The application device according to claim 4, wherein the deformation portion has an S-shaped bending structure formed by extending from the first end to the second end in a straight line and/or a curved line.

6. The application device according to claim 5, wherein a width of the deformation portion gradually increases from the first connecting portion to the second connecting portion, and extension lines of two sides of the deformation portion in a width direction intersect at one point to form an acute angle in a direction that the first connecting portion is far away from the second connecting portion; or
the width of the deformation portion gradually decreases from the first connecting portion to the second connecting portion, and the extension lines of the two sides of the deformation portion in the width direction intersect at one point to form an acute angle in a direction that the second connecting portion is far away from the first connecting portion.

7. The application device according to claim 5, wherein in the deformation portion, one bending segment is formed by bending the deformation portion once, ends of two bending segments adjacent to each other are connected by an arc segment, and line widths of the arc segment and the two bending segments connected to the arc segment are configured equal or gradually changed.

8. The application device according to claim 5, wherein line widths of the first connecting portion, the second connecting portion, and the bending segment and the arc segment located in the widened area are greater than line widths of the bending segment and the arc segment in the non-widened area.

9. The application device according to claim 7, wherein a gap between the first connecting portion and the bending segment adjacent to the first connecting portion, a gap between the two adjacent bending segments, a gap between the second connecting portion and the bending segment adjacent to the second connecting portion, and a diameter of the arc segment are greater than or equal to a thickness of the elastic member.

10. The application device according to claim 7, wherein an opening is formed at a position between the two bending segments adjacent to each other oppose to the arc segment, the opening located in the non-widen area is provided with a damping member, and the damping member connects the two bending segments adjacent to each other.

11. The application device according to claim 4, wherein a central area is provided between the first end and the second end; and the deformation portion is formed by extending from the first end to the central area along a first direction in a straight line and/or a curve and then extending from the central area to the second end along a direction opposite to the first direction in a straight line and/or a curve.

12. The application device according to claim 11, wherein the deformation part has a spiral structure, the deformation part is formed by spirally extending from the first end to the central area to the central area in clockwise or anticlockwise direction and then spirally extending from the central area to the second end in anticlockwise or clockwise direction.

13. The application device according to claim 12, wherein in the deformation portion, one spiral segment is formed by bending the deformation portion once, and any two spiral segments adjacent to each other are disposed at intervals.

14. The application device according to claim 13, wherein line widths of the first connecting portion, the second connecting portion, and the spiral segment located in the widened area are greater than a line width of the spiral segment in the non-widened area.

15. The application device according to claim 13, wherein a gap between the first connecting portion and the spiral segment adjacent to the first connecting portion, a gap between the two spiral segments adjacent to each other and a gap between the second connecting portion and the spiral segment adjacent to the second connecting portion are greater than or equal to a thickness of the elastic member.

16. The application device according to claim 15, wherein a damping member is provided at each of a gap between the spiral segment connected to the first connecting portion and a spiral segment adjacent thereto, a gap between the spiral segment connected to the second connecting portion and a spiral segment adjacent thereto respectively, and the damping member connects the two spiral segments adjacent to each other.

17. (canceled)

18. The application device according to claim 1, wherein the application device further comprises a vibration unit, and the elastic member is used to balance the vibration of the vibration unit in a predetermined direction,
the vibration unit is configured in at least three elastic members, and the at least three elastic members are uniformly disposed at intervals along a periphery of the vibration unit.

19. (canceled)

20. (canceled)

21. The application device according to claim 1, wherein two of the elastic members have conductive body structure, and remaining elastic member has non-conductive body structure.

22. The application device according to claim 1, wherein the application device further comprises a holder, and the vibration unit comprises a diaphragm and a voice coil connected to the diaphragm; the first connecting portion is connected to the voice coil, and the second connecting portion is connected to the holder; or
the vibrating unit comprises a diaphragm, a voice coil and a cup, the voice coil and the cup are connected at the same side of the diaphragm, the first connecting portion is connected to the cup, and the second connecting portion is connected to the holder; and/or
the holder is a housing or a magnetic yoke.

23. The application device according to claim 1, wherein the application device is a loudspeaker, a motor or a multi-functional vibrating device.
